(19) United States
(12) Patent Application Publication
(10) Pub. No.: US 2017/0364755 A1
(43) Pub. Date: Dec. 21, 2017

(54) Systems and Methods for Tracking Movements of a Target

(71) Applicant: Beijing Xiaomi Mobile Software Co., Ltd., Beijing (CN)

(72) Inventors: Ke WU, Beijing (CN); Tao CHEN, Beijing (CN); Huayijun LIU, Beijing (CN)

(73) Assignee: Beijing Xiaomi Mobile Software Co., Ltd., Beijing (CN)

(21) Appl. No.: 15/411,072

(22) Filed: Jan. 20, 2017

(30) Foreign Application Priority Data
Jun. 21, 2016 (CN) 201610453399.8

(51) Int. Cl. G06K 9/00; G06T 7/292; H04N 7/18

(52) U.S. Cl. CPC G06K 9/00771; H04N 7/188; G06T 7/292; H04N 7/181

(57) ABSTRACT

Systems and methods for determining a movement track of a target are provided. In some aspects, a method includes obtaining target image information captured using a current imaging device, and determining whether preset information exists in the target image information. The method also includes obtaining, based on the determination, a geographic location of the current imaging device, and determining the movement track of the target using the geographic location and a motion state of the target. The method further includes generating a report indicating the movement track.

### CROSS-REFERENCE TO RELATED APPLICATION

This application is based on and claims priority to Chinese Patent Application Serial No. 201610453399.8, filed with the State Intellectual Property Office of P. R. China on Jun. 21, 2016, the entire content of which is incorporated herein by reference.

### TECHNICAL FIELD

The present disclosure generally relates to the monitoring technologies, and more particularly to systems and methods for tracking the movements of targets.

### BACKGROUND

Nowadays, monitoring systems are installed in many places. Existing systems are typically only used for observation, with analysis being performed at a later time as needed. However in some applications, the movement of targeted objects or people need to be tracked in real-time and with high accuracy. To date, accurate methods for real-time tracking are lacking. This can present a potential security risk to the safety of a monitored area or persons in the monitored area.

### SUMMARY

The embodiments of the present disclosure provide systems and methods for accurately determining movements of a target. The technical solutions are described as follows.

In accordance with one aspect of the disclosure, a method for determining a movement track of a target is provided. The method includes obtaining target image information captured using a current imaging device, and determining whether preset information exists in the target image information. The method also includes obtaining, based on the determination, a geographic location of the current imaging device, and determining the movement track of the target using the geographic location and a motion state of the target. The method further includes generating a report indicating the movement track.

In accordance with another aspect of the disclosure, a system for determining a movement track of a target is provided. The system includes an input for receiving target image information captured using at least one imaging device, a processor, and a memory having stored therein non-transitory instructions executable by the processor. The processor, in executing the instructions is configured to obtain the target image information, determine whether preset information exists in the target image information, and obtain, based on the determination, a geographic location of the current imaging device. The processor is also configured to determine the movement track of the target using the geographic location and a motion state of the target, and generate a report indicating the movement track. The system further includes an output for displaying the report.

In yet another aspect of the present disclosure, a non-transitory computer-readable storage medium is provided having stored therein instructions that, when executed by a processor of a system, causes the system to perform steps for obtaining a movement track of a target. The steps include obtaining the target image information, determining whether preset information exists in the target image information, and obtaining, based on the determination, a geographic location of the current imaging device. The steps also include determining the movement track of the target using the geographic location and a motion state of the target, and activating at least one imaging device along the movement track.

It should be understood that both the foregoing general description and the following detailed description are exemplary and explanatory only, and shall not be construed to limit the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart showing a method for obtaining a movement track of a target, according to an example embodiment.

FIG. 2 is a flowchart showing another method for obtaining a movement track of a target, according to an example embodiment.

FIG. 3 is a flowchart showing yet another method for obtaining a movement track of a target, according to an example embodiment.

FIG. 4 is a flowchart showing yet another method for obtaining a movement track of a target, according to an example embodiment.

FIG. 5 is a flowchart showing yet another method for obtaining a movement track of a target, according to an example embodiment.

FIG. 6 is a block diagram showing a device for obtaining a movement track of a target, according to an example embodiment.

FIG. 7 is a block diagram showing another device for obtaining a movement track of a target, according to an example embodiment.

FIG. 8 is a block diagram showing another device for obtaining a movement track of a target, according to an example embodiment.

FIG. 9 is a block diagram showing yet another device for obtaining a movement track of a target, according to an example embodiment.

FIG. 10 is a block diagram showing yet another device for obtaining a movement track, according to an example embodiment.

FIG. 11 is a block diagram showing a device for obtaining a movement track, according to an example embodiment.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the invention as recited in the appended claims.

Nowadays, monitors are installed in many places for purposes of security and activity monitoring. In general, existing systems provide passive monitoring using indoor or outdoor cameras. Analysis of persons or objects of interest in the captured images can then carried out at a later time by an investigator through visual inspection or using specialized recognition software. Many situations, however, require real-time identification and tracking of imaged objects of persons. For instance, an identity and/or movement track of a person of interest, such as an escaped or suspected fugitive or criminal, might need to be determined while the person is moving. However, accurate tracking might depend on knowledge of the person of interest's origin and intended movement track, as well as the availability or activity of monitoring systems along the movement. A lack of real-time imaging information and adaptive analysis would result in information gaps and uncertainty in locating or identifying the person of interest, leading to potential security risks to public safety.

To solve the technical problems described above, methods for determining a movement track of a target are herein provided. The methods, as detailed below, may be carried out using any suitable system, apparatus or device having capabilities or configured in accordance with the present disclosure. For instance, the methods may be implemented using a imaging device or system that includes or has access to devices with image capture capabilities, such as a monitoring system having covering a building, a community area, an airport terminal, a bus/train station, or other public or private areas. In some aspects, methods described herein may be implemented using one or more computers, workstations, servers, or mobile devices, such as cellphones, tablets, laptops and the like.

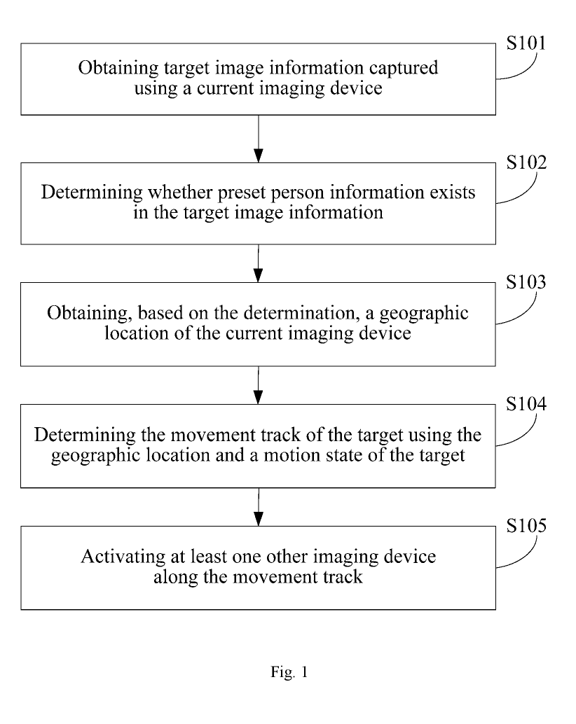

Referring now to FIG. 1, in one embodiment, a method includes the following steps S101 to S105.

In step S101, target image information captured using a current imaging device or system is obtained. The target image information, in the form of single or multiple images or image data captured intermittently or continuously over a certain period of time, may be acquired directly from the imaging device using a suitable input, such as via a wired or wireless connection. As such, the current imaging device may be configured with one or more cameras or other imaging hardware configured for capturing a scene. In some aspects, the target image information may be accessed from a database, server, or other data storage location. Target imaging information may be obtained using a wired or a wireless connection, such as via WiFi network, Bluetooth or Mobile data network.

In step S102, an analysis is performed to determine whether preset information is present in the target image information obtained. The preset information be stored on one or more cellphones or other portable devices, a database, a server, a local or national security system or information network, and so forth, and accessed intermittently or continuously, either automatically or as a result of a user indication.

The preset information may include information associated with one or more objects or persons, such as preset actions or movements, as well as features and appearances. For instance, the preset information may include specific feature information of a person, such height, weight, build, face frame and size, eye shape, skin color, as well as distinguishing features such as a mole on the face, and so forth. The preset information may also include gait, mannerism, body orientation or expressions, and so on.

Non-limiting examples of preset actions include knife related actions (e.g. an action with knife), gun related actions (e.g. an action with gun), actions of hitting or dragging people, and so forth. Non-limiting examples of preset gaits include staggering, running, limping, walking and so forth. Non-limiting examples of preset expressions may include surprise, panic, fear or grim expressions, and so forth.

If the preset information is found in the target image information, a geographic location of the imaging device capturing the target image information may then be obtained, as indicated by step S103. In this manner, a current or prior location of the target may be identified. If preset information is not found in the target image information, steps S101 and S102 may be repeated using the imaging device or any other imaging systems or devices.

In addition to a location of the target, a movement track of the target may also be estimated or predicted, as indicated in step S104, where the movement track is indicative of a possible route that the target might follow. In some aspects, the movement track may be estimated using the geographic location of the imaging device and a motion state of the target. In particular, information associated with the motion state of a target may include motion parameters, such as movement rate and direction, which may be obtained by applying various image or feature analysis techniques to target image information. By way of example, a Kalman filter algorithm may be utilized, as well as other image processing techniques. In some aspects, the motion state may be estimated by analyzing gait, or the appearance certain features of the target, such as body or body part movement and orientation. Since target movements may also result from other activities besides walking or running, such as cycling, riding motorcycles or electric bikes, driving or taking ferry, or using other modes of transportation, the motion state may also be estimated by analyzing other objects or features in an imaged scene or area.

In some aspects, other imaging devices or systems may be activated based on the estimated movement track, as indicated by step S105. Such imaging devices or systems are different than the current imaging device described with respect to step S101, and may be part of the same or different monitoring system(s) or network(s) and positioned along the determined movement track. Other imaging devices can also include portable devices, such as cellphones, laptops, tablets, and the like. In some aspects, a report may be generated at S104 and include any desirable information. The report may indicate past, current and future locations of the target based on estimated movement track, as well as other information. In some aspects, the report may be provided in substantially real-time using a display.

Steps S101-S104 may then be repeated using one or more of such activated imaging systems. The estimated movement track may therefore be adapted based on new image information. As appreciated from the above, using multiple imaging systems or devices along the movement track of the target allows for real-time as well as more accurate tracking and prediction of target movements. In addition, activating imaging systems along the movement track can also provide continuous image information, without gaps, that may be analyzed at a later time.

In one embodiment, step S104 described with respect to FIG. 1, may be executed as follows.

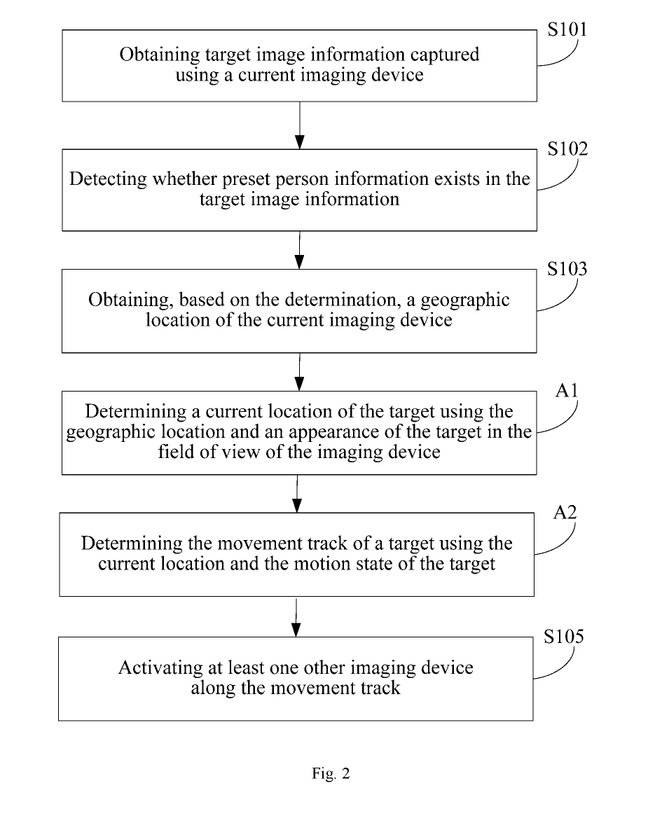

Referring specifically to FIG. 2, in step A1, a current location of the target may be determined using the geographic location of the imaging device and more particularly using the location of target in the field of view of the imaging device. In particular, the location of target in the imaged area may be determined by analyzing the target image information obtained. For example, the position and size of the target, or a portion thereof, as appearing in field of view of the imaging device, combined with predetermined area or geometrical information or landmarks may be used to determine the current location of the target.

At step A2, the movement track of the target may then be estimated using the current location and the motion state of the target. As described, information associated with the motion state may include movement rate and direction, which may depend upon whether the target is walking, cycling, riding electric bike, driving or taking ferry and so forth. As such, the movement track of a target may be more accurately determined, providing a better estimate for the track a future location of the target.

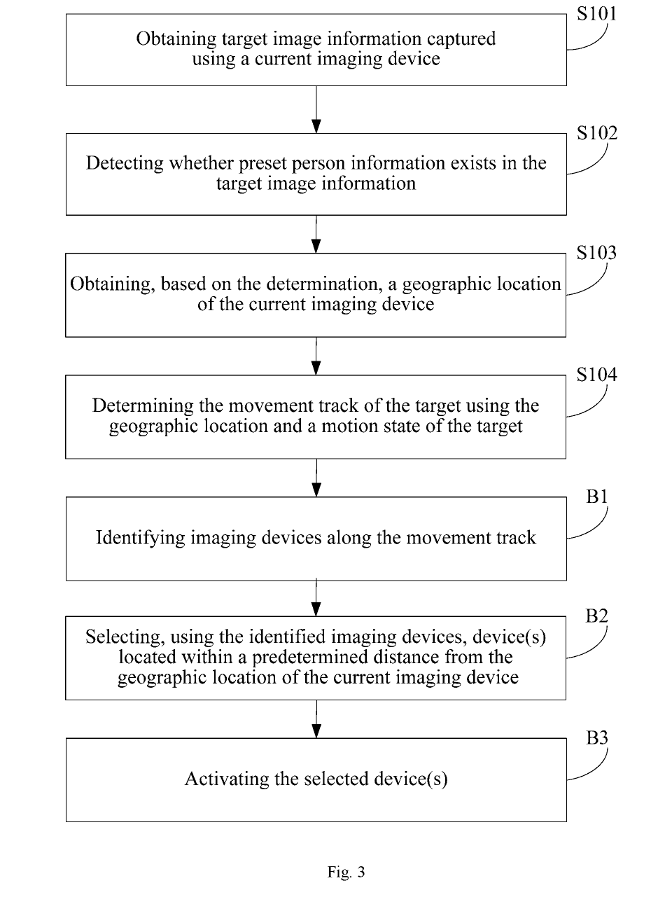

As shown in FIG. 3, in an embodiment, step S105 shown in FIG. 1 described above may be executed as follows.

In step B1, a number of imaging devices or systems along the movement track may be identified.

In step B2, imaging devices or systems that are located within a predetermined distance from the geographic location of the current imaging device may be selected. For example, the predetermined distance may be approximately 1 km, although other distances may be possible.

In step B3, selected imaging systems or devices within the predetermined distance may then be activated to image the target. Activation may include transmitting to the respective imaging systems or devices activation signals to take effect either instantaneously or with a timed delay that can depend upon the distance of the particular imaging system or device from the target, as well as the motion state of the target. In some aspects, the imaging system(s) or device(s) nearest to the target can be activated.

Steps S101-S014 may then be repeated using the activated imaging systems or devices, and the movement track of the target may be updated based on new image information. In this manner, the actual movements of the target and likely future locations may be more accurately determined.

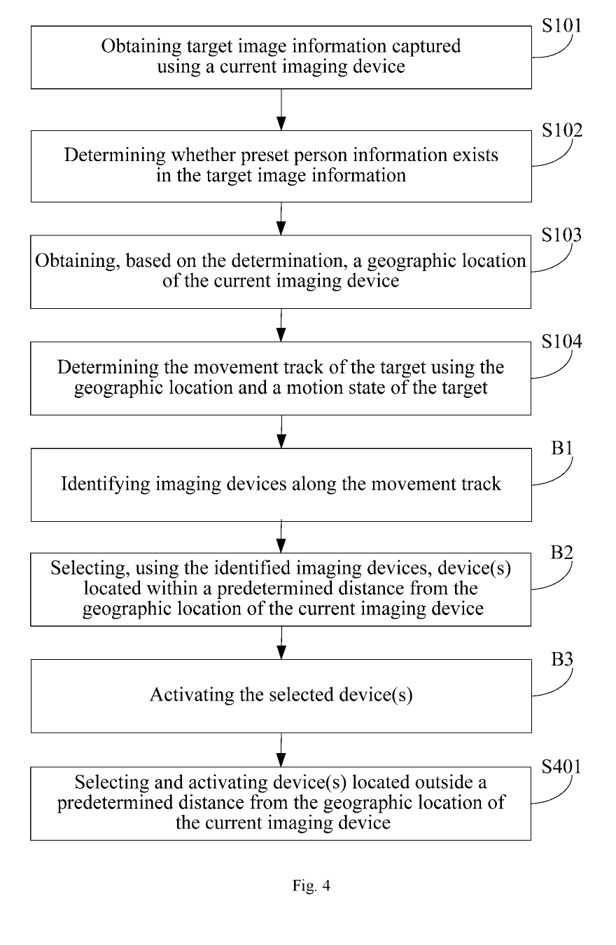

As shown in FIG. 4, in an embodiment, the method describe above further includes the following step.

In step S401, imaging systems or devices that are located outside the predetermined distance may also be identified and activated. This is because if a target is not tracked by nearby imaging systems or devices activated at step B3, in order not to lose track of the target, other systems or devices that are further away along the movement track can be activated.

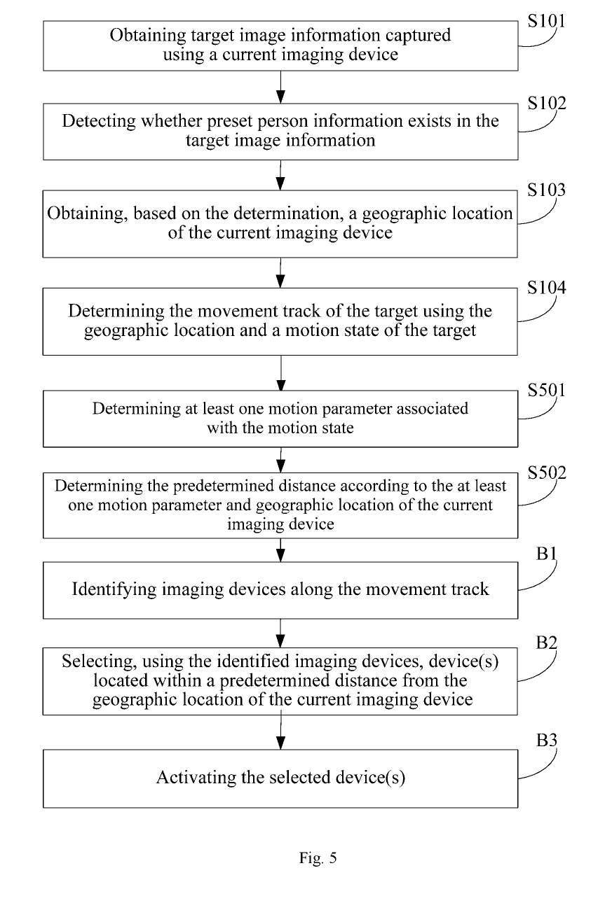

As shown in FIG. 5, in an embodiment, before step B2 is executed, the method described above further includes the following steps.

In step S501, one or more motion parameters corresponding to the motion state of the target are determined, where motion parameter can include a movement rate and direction of the target. Generally, different motion states correspond to different motion parameters, and the motion parameter of the target shows relative stability and consistency instead of sudden great change in a certain period under the same motion state. Therefore, the current motion parameter of the target may be predicted according to the motion state thereof.

In step S502, the predetermined distance may be determined according to determined motion parameters and the geographic location of the current imaging device. As appreciated from the above, when the movement rate of the target is fast, the number of imaging devices required might be large in case the target is missed. Therefore, the predetermined distance that is suitable to the current motion parameter may be determined so as to adopt suitable number of imaging systems devices. In addition, the numbers of cameras within the same predetermined distance can depend based on different geographic locations, e.g. mountainous or rural areas compared to urban areas. Thus, the current geographic location may be also considered when determining the predetermined distance.

In an embodiment, step B2 shown in FIG. 5 described above may be executed as follows.

The target camera device, from which the distance to the current geographic location is less than or equal to the predetermined distance and whose direction corresponds to the current moving direction, is determined from the camera devices.

The target camera device, from which the distance to the current geographic location is less than or equal to the predetermined distance and whose direction corresponds to (i.e. be consistent with) the current moving direction, may be determined from the camera devices when determining the target camera device, such that the target may be effectively captured so as to track and confirm the actual movement track of the target with not only the smallest number of the target camera devices, but with a decreased power consumption.

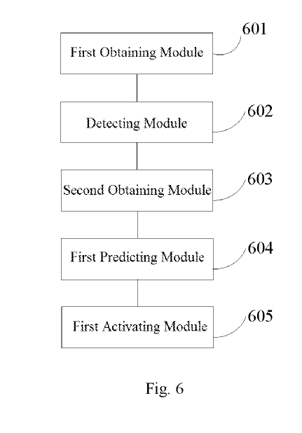

In one embodiments of the present disclosure, a system or device for obtaining a movement track of a target is provided. As shown in FIG. 6, the system or device may include a first obtaining module 601, a detecting module 602, a second obtaining module 603, a first predicting module 604, and a first activating module 605.

The first obtaining module 601 is configured to obtain target image information captured.

The detecting module 602 is configured to detect whether preset information exists in the target image information. The detecting module 602 may determine whether a target corresponding to preset information exists in the target image information by detecting whether preset information exists in the target image information, and if the target exists in the target image information, the target may be the specific person the user wants to track, or the escaped criminals or suspects and so forth, according to the specific definition to the preset information.

The second obtaining module 603 is configured to obtain a current geographic location of a current imaging system capturing the target image information if the preset information exists in the target image information.

The first predicting module 604 is configured to predict the movement track of a target according to the current geographic location and a motion state of the target corresponding to the preset information. As described, the motion state may be directly obtained or estimated from the gait or other appearances or features of the target.

The geographic location of the current imaging system capturing the target image information can be automatically obtained if the above preset information exists in the target image information, such that the movement track of the target can be automatically and accurately predicted according to the geographic location and the motion state of the target.

The first activating module 605 is configured to activate one or more imaging systems or devices along the movement track. These, along with the current imaging system, can be part of the same or a different monitoring system(s), and may be connected via wired or wireless way, such as by WiFi network, Bluetooth or Mobile data network.

After the movement track is estimated, since the actual movement track of the target may change, various imaging systems along the movement track may be activated so as to factually capture the target in time to accurately determine a final actual movement track of the target, and record the actual movement. This avoids gaps in target imaging information, and avoids potential security risks.

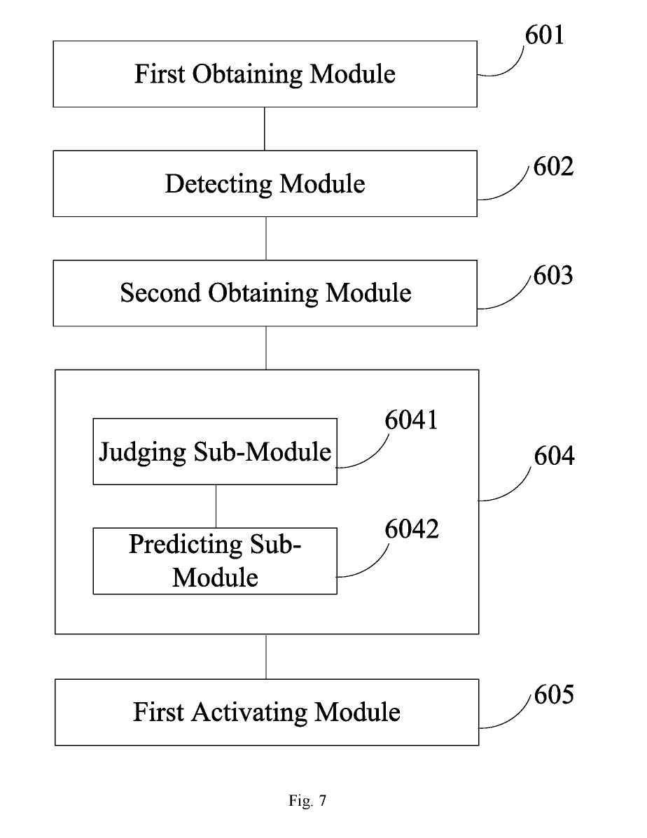

As shown in FIG. 7, in an embodiment, the first predicting module 604 may include: a judging sub-module 6041 and a predicting sub-module 6042.

The judging sub-module 6041 is configured to judge or determine a current location of the target according to the geographic location of a current imaging system and a location of the preset information in the target image information. As described, a target may appear in different positions in the field of view of the current imaging system. Hence, the current location of the target, i.e. an actual position coordinate, may be accurately judged according to the geographic location of the current imaging system and the location of the preset information in the target image information.

The predicting sub-module 6042 is configured to estimate or predict the movement track of the target depending on the current location and the motion state of the target. As described, the motion state may be described by various motion parameters, such as movement rate, and direction.

The movement track of the target may be accurately predicted according to the actual current location and the motion state of target. Specifically, different current motion states may correspond to different motion parameters. Therefore an approximate moving rate and moving direction may be obtained according to the current motion state, and thus the movement track of the target may be accurately predicted. In some aspects, various image analysis algorithms, such as Kalman filter algorithm, may be used to identify the motion parameters.

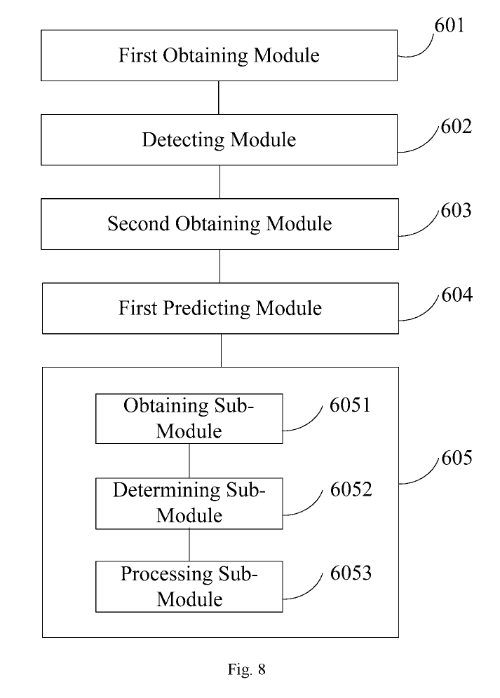

As shown in FIG. 8, in an embodiment, the first activating module 605 may include: an obtaining sub-module 6051, a determining sub-module 6052, and a processing sub-module 6053.

The obtaining sub-module 6051 is configured to identify or obtain imaging systems or devices along the movement track of a target.

The determining sub-module 6052 is configured to determine, from the identified imaging systems or devices, those that are located at a predetermined distance within the geographic location of a current imaging system.

The processing sub-module 6053 is configured to activate various imaging systems or devices to image the target and to update the movement track according to the imaging information captured.

Since there may be a large number imaging systems or devices along the movement track and those located far away from the target cannot provide useful imaging data, in some aspects, those systems or devices within the predetermined distance that are nearest to the geographic location of the current imaging system may are activated. Thus, the target may be imaged by the selected imaging systems or devices when the target moves into their respective field of view. Besides, the current target location may be automatically determined again when the target is imaged, so that the predicted movement track appropriately updated. Additionally, the movement track of the target can be continually updated, corrected and modified by continually repeating the steps above. In this manner, the latest actual movement track may be obtained.

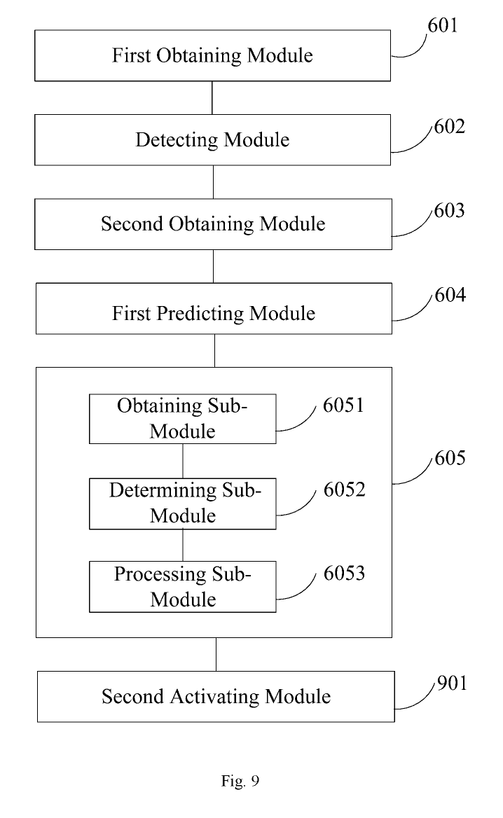

As shown in FIG. 9, in an embodiment, the device described above further includes: a second activating module 901.

The second activating module 901 is configured to activate other imaging systems or devices along the movement track, from which the distance to the geographic location of the current imaging system is greater than the predetermined distance. The second activating module 901 may activate such systems or devices if the target is not imaged by imaging systems or devices activated by the first activating module 605.

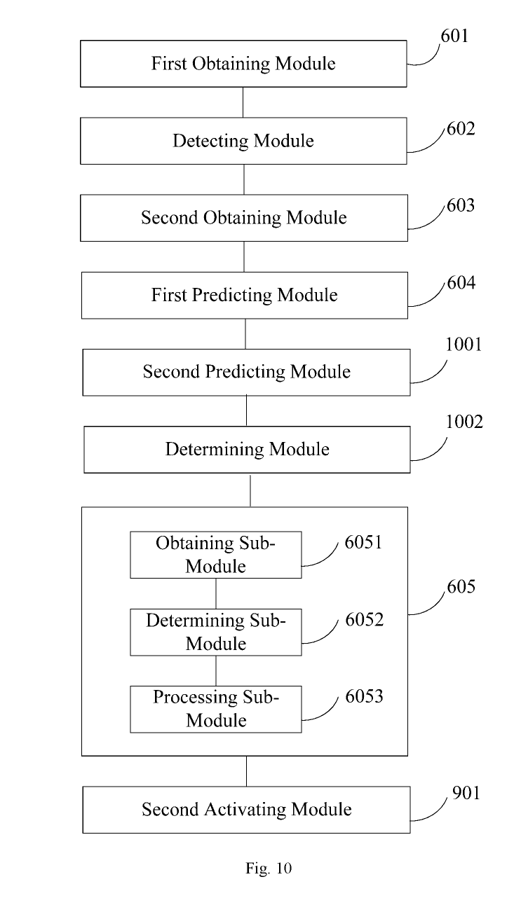

As shown in FIG. 10, in an embodiment, the device described above further includes: a second predicting module 1001 and a determining module 1002.

The second predicting module 1001 is configured to predict at least one motion parameter of the target according to the motion state before the imaging system or device located within predetermined distance is determined. As described, motion parameters can include the movement rate and direction.

The determining module 1002 is configured to determine the predetermined distance according to the current motion parameter and the current geographic location.

Since different motion states may correspond to different motion parameters, the numbers of camera devices in different predetermined distances can be different, and different numbers of cameras are required due to different current motion parameters of the target (e.g. when the moving rate of the target is fast, the number of camera device required is large in case the target is missed by the camera devices), therefore, the predetermined distance which is suitable to the current motion parameter and the current geographic location may be determined according to the current motion parameter and the current geographic location after the current motion parameter is predicted depending on the motion state, so as to adopt suitable number of camera devices to shoot the target and obtain the latest movement track of the target in time.

Furthermore, as the numbers of the camera devices in the same distance are different depending on different geographic locations, e.g. in the same distance, the number of the camera devices in a mountainous area is much less than that in an urban area, thus, the current geographic location may be also considered when determining the predetermined distance.

In an embodiment, the determining sub-module 6052 described above may include: a determining unit. The determining unit is configured to determine, from the identified imaging systems or devices along the movement track, those imaging systems or devices positioned within predetermined distance and correspond to the current moving direction of the target.

When determining the target camera device, the determining unit may select one camera device from the camera devices such that the distance between the selected camera device and the current geographic location is less than or equal to the predetermined distance and whose direction corresponds to (i.e. be consistent with) the current moving direction of the target. Thus, the target may be effectively shot so as to track and confirm the actual movement track of the target with not only the smallest number of the target camera devices, but also with a decreased power consumption.

According to another aspect the present disclosure, there is provided a device or system for obtaining a movement track of a target, the device includes: an input for receiving image and other information, an output for displaying a report, a processor and a memory configured to store an instruction executable by the processor.

The processor is configured to:

obtain target image information captured;

detect whether preset information exists in the target image information;

obtain a current geographic location of a current camera device capturing the target image information if the preset information exists in the target image information;

predict a movement track of a target according to the current geographic location and a motion state of the target corresponding to the preset information; and

activate a target camera device along the movement track.

The processor described above predicts the movement track of the target according to the current geographic location and the motion state of the target corresponding to the preset information by:

judging a current person location of the target according to the current geographic location and a location of the preset information in the target image information; and

predicting the movement track of the target according to the current person location and the motion state, in which the motion state includes at least one of a current motion mode and a historical motion parameter of the target.

The processor described above activates the target camera device along the movement track by:

obtaining camera devices along the movement track;

determining, from the camera devices, the target camera device from which the distance to the current geographic location is less than or equal to a predetermined distance; and

activating the target camera device to shoot the target, and updating the movement track when the target is captured.

The processor described above may be further configured to:

activate other camera devices along the movement track, from which the distance to the current geographic location is greater than the predetermined distance, if the target is not captured after the target camera device is activated.

Before the target camera device from which the distance to the current geographic location is less than or equal to the predetermined distance is determined from the camera devices, the processor described above may further:

predict a current motion parameter of the target according to the current motion state, in which the current motion parameter includes one or more of a current moving rate and a current moving direction; and

determine the predetermined distance according to the current motion parameter and the current geographic location.

The processor described above may further determine, from the camera devices, the target camera device from which the distance to the current geographic location is less than or equal to a predetermined distance by:

determining, from the camera devices, the target camera device from which the distance to the current geographic location is less than or equal to the predetermined distance and whose direction corresponds to the current moving direction.

The preset information includes at least one of the preset image information, the preset action, the preset gait and the preset expression.

In another aspect of the present disclosure, a device for obtaining a movement track of a target is provided. The device includes:

a first obtaining module configured to obtain target image information captured;

a detecting module configured to detect whether preset information exists in the target image information;

a second obtaining module configured to obtain a current geographic location of a current camera device capturing the target image information if the preset information exists in the target image information;

a first predicting module configured to predict the movement track of a target according to the current geographic location and a motion state of the target corresponding to the preset information; and

a first activating module configured to activate a target camera device along the movement track.

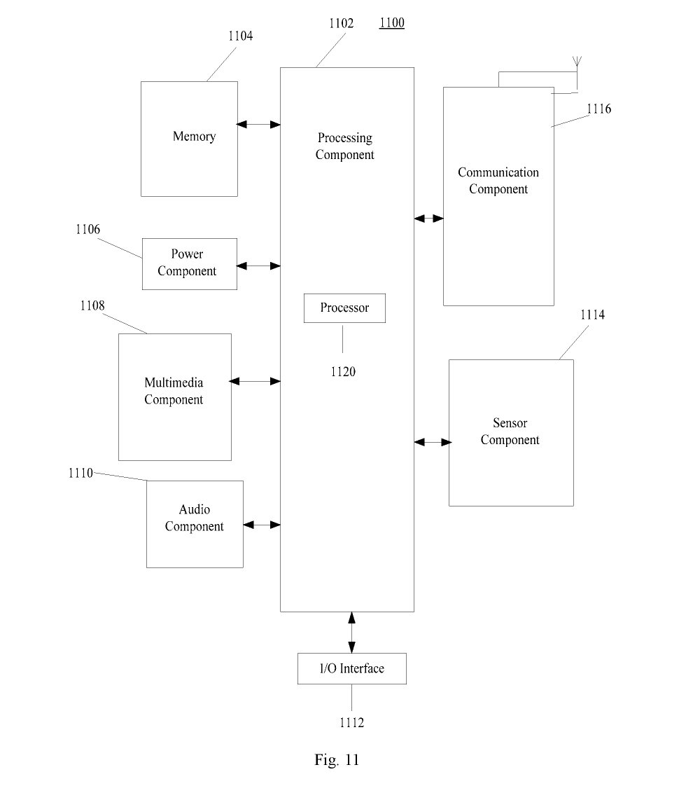

FIG. 11 is a block diagram showing a device 1100 for determining a movement track of a target in accordance with aspects of the present disclosure. By way of example, the device 1100 may be a mobile phone, a computer, a digital broadcasting terminal, a messaging device, a game console, a tablet device, a medical equipment, a fitness equipment, a Personal Digital Assistant PDA, and so forth.

Referring to FIG. 11, the device 1100 may generally include a processing component 1102, a memory 1104, a power component 1106, a multimedia component 1108, an audio component 1110, an Input/Output (I/O) interface 1112, a sensor component 1114, and a communication component 1116. In some aspects, input/output interface 1112 may be configured for displaying a report, such as a report indicating an estimated and/or performed movement track of a target.

The processing component 1102 may be configured to control the operations of the device 1100, such as the operations associated with display, telephone calls, data communications, camera operations, and recording operations. The processing component 1102 may include at least one processor 1120 configured to execute non-transitory instructions to perform all or part of the steps in the above described methods. For example, the processing component 1102 may be configured to read and execute non-transitory instructions stored in the memory 1104. In some aspects, the processing component 1102 may be configured to determine a movement track of a target, as described. Moreover, the processing component 1102 may include at least one module that facilitates the interaction between the processing component 1102 and other components. For instance, the processing component 1102 may include a multimedia module to facilitate the interaction between the multimedia component 1108 and the processing component 1102.

The memory 1104 is configured to store various types of data and information to support the operation of the device 1100. Examples of such data include instructions for any storage objects or methods operated on the device 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. In some aspects, the memory 1104 may include non-transitory instructions for carrying out steps in accordance with the present disclosure. In this regard, the memory 1104 may include non-transitory computer readable storage medium storing the non-transitory instructions. For example, the non-transitory computer-readable storage medium may be a ROM, a RAM, a CD-ROM, a magnetic tape, a floppy disc, an optical data storage device, and the like.

The power component 1106 provides power to various components of the device 1100. The power component 1106 may include a power management system, one or more power sources, and any other components associated with the generation, management, and distribution of power in the device 1100.

The multimedia component 1108 includes a screen providing an output interface between the device 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. In some embodiments, the multimedia component 1108 includes a front camera and/or a rear camera. The front camera and/or the rear camera may receive external multimedia data while the device 1100 is in an operation mode, such as a shooting mode or a video mode. Each of the front camera and the rear camera may be a fixed optical lens system or have focus and optical zoom capability.

The audio component 1110 is configured to output and/or input audio signals. For example, the audio component 1110 includes a microphone (MIC) configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface for the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an open/closed status of the device 1100 and relative positioning of components (e.g. the display and the keypad of the device 1100). The sensor component 1114 may also detect a change in position of the device 1100 or of a component in the device 1100, a presence or absence of user contact with the device 1100, an orientation or an acceleration/deceleration of the device 1100, and a change in temperature of the device 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate wired or wireless communication between the device 1100 and other devices. The device 1100 can access a wireless network based on a communication standard, such as WIFI, 2G or 3G or a combination thereof. In one example embodiment, the communication component 1116 receives a broadcast signal or broadcast associated information from an external broadcast management system via a broadcast channel. In one example embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the device 1100 may be implemented with one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus may use the circuitries in combination with the other hardware or software components for performing the above described methods. Each module, sub-module, unit, or sub-unit disclosed above may be implemented at least partially using the one or more circuitries.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art.

It is intended that the specification and examples be considered as exemplary only, with a true scope and spirit of the invention being indicated by the following claims. It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for determining a movement track of a target, comprising:
obtaining target image information captured using a current imaging device;
determining whether preset information exists in the target image information;
obtaining, based on the determination, a geographic location of the current imaging device;
determining the movement track of the target using the geographic location and a motion state of the target; and
generating a report indicating the movement track.

2. The method of claim 1, wherein determining the movement track further comprises identifying a current location of the target using the geographic location and an appearance of the target in a field of view of the imaging device.

3. The method of claim 1, further comprising:
determining the motion state by analyzing the target image information captured using the current imaging device.

4. The method of claim 1, further comprising:
identifying a plurality of imaging devices along the movement track.

5. The method of claim 4, further comprising:
using the motion state of the target when identifying the plurality of imaging devices.

6. The method of claim 4, further comprising:
selecting, using the identified imaging devices, at least one device located within a predetermined distance from the geographic location of the current imaging device; and
activating the at least one device selected.

7. The method of claim 6, further comprising:
selecting, using the identified imaging devices, at least one device located outside predetermined distance from the geographic location of the current imaging device; and
activating the at least one device selected.

8. The method of claim 6, further comprising:
determining the predetermined distance according the geographic location and at least one motion parameter associated with the motion state.

9. The method of claim 8, wherein the at least one motion parameter comprises at least one of a movement rate and a movement direction.

10. The method of claim 6, further comprising:
acquiring updated target image information using the at least one device activated and updating the movement track based on the updated target information.

11. The method of claim 1, wherein the preset information comprises at least one of a preset image information, a preset action, a preset gait and a preset expression.

12. A system for determining a movement track of a target, the system comprising:
an input for receiving target image information captured using at least one imaging device;
a processor; and
a memory having stored therein non-transitory instructions executable by the processor,
wherein the processor in executing the instructions is configured to:
obtain the target image information;
determine whether preset information exists in the target image information;
obtain, based on the determination, a geographic location of a current imaging device;
determine the movement track of the target using the geographic location and a motion state of the target;
generate a report indicating the movement track; and
an output for displaying the report.

13. The system of claim 12, wherein the processor is further configured to determine the movement track by identifying a current location of the target using the geographic location and an appearance of the target in a field of view of the imaging device.

14. The system of claim 12, wherein the processor is further configured to determine the motion state by analyzing the target image information captured using the current imaging device.

15. The system of claim 12, wherein the processor is further configured to identify a plurality of imaging devices along the movement track.

16. The system of claim 15, wherein the processor is further configured to use the motion state of the target when identifying the plurality of imaging devices.

17. The system of claim 15, wherein the processor is further configured to:
select, using the identified imaging devices, at least one device located relative to a predetermined distance from the geographic location of the current imaging device; and
activate the at least one device selected.

18. The system of claim 17, wherein the processor is further configured to determine the predetermined distance according the geographic location and at least one motion parameter associated with the motion state.

19. The system of claim 18, wherein the processor is further configured obtain updated target image information acquired using the at least one device activated and update the movement track based on the updated target information.

20. A non-transitory computer-readable storage medium having stored therein instructions that, when executed by a processor of a system, causes the system to perform steps for obtaining a movement track of a target comprising:
obtaining target image information;
determine whether preset information exists in the target image information;
obtaining, based on the determination, a geographic location of a current imaging device;
determining the movement track of the target using the geographic location and a motion state of the target; and
activating at least one imaging device along the movement track.
